(19) United States
(12) Patent Application Publication
(10) Pub. No.: US 2007/0008345 A1
(43) Pub. Date: Jan. 11, 2007

(54) Display system for an industrial device

(76) Inventors: R. Mike McDonald, Fort Collins, CO (US); Greggory W. Pulley, Berthoud, CO (US); Michael Lynn Westra, Windsor, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/177,807

(22) Filed: Jul. 8, 2005

(51) Int. Cl. G09G 5/00

(52) U.S. Cl. 345/659

(57) ABSTRACT

A system and method for displaying information on an industrial apparatus is described. In one variation, the industrial device is arranged so as to place a display panel of the industrial device in an orientation relative to an industrial system. The industrial device is then installed in the industrial system so as to fix the orientation of the display panel with the orientation. A presentation of the content on the display panel is changed in response to orientation of the display panel relative to a viewing perspective of a user.

### FIELD OF THE INVENTION

The present invention relates to industrial devices. In particular, but not by way of limitation, the present invention relates to systems and methods for displaying information on industrial control devices.

### BACKGROUND OF THE INVENTION

Many industrial devices are amenable to being installed in an industrial system with a variety of orientations. A mass flow controller, for example, may be installed in one fluid transport line with a first side facing up in one orientation, and the same controller may be installed in another transport line with the first side facing down in another orientation.

Many control devices include display panels that provide information about a status of the control device and/or a status of the process the control device is associated with. For example, control devices are often capable of displaying information such as temperature, pressure, percent of full load, alarm information and/or error information.

Although control devices may mechanically and electrically operate without a problem in many orientations, when a control device includes a fixed display panel that moves along with the control device, the display panel may be installed upside-down relative to the perspective of an operator of the control device. As a consequence, the information on the display is at least an inconvenience for the operator to read, and worse, the information may be misread by the operator, which may cause a costly interruption to the process, damage to the system or even personal injury.

In an attempt to alleviate these display issues, some devices incorporate a display panel that is mechanically adjustable so that an operator can change the physical orientation of the display panel while the control device is installed in a system. These mechanically adjustable displays are often awkward to adjust, prone to slipping and/or adversely affect the structural integrity of the control device. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one exemplary embodiment, the present invention may be characterized as a method for presenting information from an industrial device to a user. In this embodiment, the method includes arranging the control device so as to place a display panel of the control device in an orientation relative to an industrial system, installing the control device in the control system so as to fix the orientation of the display panel with the orientation and changing the presentation of content on the display panel in response to the orientation of the display panel relative to a viewing perspective of a user.

In another embodiment, the invention may be characterized as an industrial apparatus including at least one connector that is configured so as allow the control apparatus to be coupled to an industrial system in a plurality of orientations. The industrial apparatus includes a display panel configured to display status information relating to the industrial system and a processor configured to receive an orientation signal that is indicative of at least one of the plurality of orientations. The processor in this embodiment is configured to alter the presentation of the status information on the display panel in response to the orientation signal.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIGS. 1A and 1B are perspective views of a control device that is positioned in a first and second respective orientations;

FIG. 2 is a block diagram depicting functional components of the control device of FIG. 1;

FIG. 3 is a flow chart depicting exemplary steps carried out when adapting a presentation of information on the control device of FIG. 1; and

FIG. 4 depicts a display panel in accordance with another embodiment of the present invention.

### DETAILED DESCRIPTION

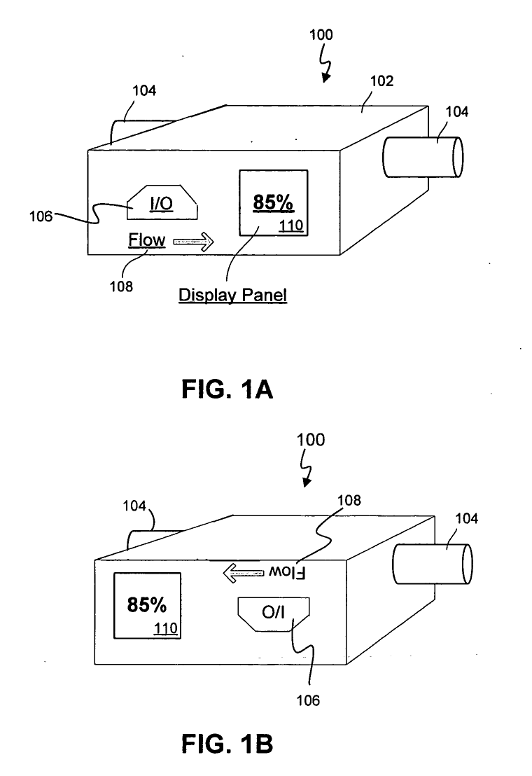

Referring now to the drawings, where like or similar elements are designated with identical reference numerals throughout the several views. Referring first to FIGS. 1A and 11B, shown are perspective views of a control device 100 in accordance with an exemplary embodiment of the invention. In FIG. 1A, the control device 100 is depicted in a first orientation, and in FIG. 1B the control device is shown in a second orientation.

As shown in FIGS. 1A and 1B, the control device includes a housing 102 and coupled to the housing 102 are connectors 104, an input/output (I/O) port 106, informational text 108 and a display panel 110. The control device 100 is depicted as a mass flow controller in FIGS. 1A and 1B, but this is certainly not required.

In one embodiment, the I/O port 106 is an Ethernet port, but in other embodiments other ports that allow for communication to and/or from the control device are be utilized (e.g., DeviceNet, RS232, RS485, analog interface, etc.). As discussed further herein, the display panel 110 in some embodiments is realized as a liquid crystal display (LCD), in other embodiments as a light emitting diode (LED) display and in yet other embodiments as organic light emitting diode (OLED) display.

In the present embodiment, the connectors 104 allow the control device 100 to be coupled to an industrial process in a variety of orientations. As depicted in FIG. 1A, for example, the control device is arranged so that the informational text 108 is readable from left to right and fluid in the control device 100 flows from left to right. The connectors in several embodiments are realized by connectors that comply with industry standards such as C-seal, W-seal, VCO, VCR and NPT.

In FIG. 1B, the control device is shown in an orientation that is rotated 180 degrees relative to the position of the control device 100 in FIG. 1A so that the informational text 108 on the housing of the control device 100 is both upside-down and the characters of the informational text are readable from right to left. But the information on the display panel 110 depicted in FIG. 1B is rendered so as to be readable in the same manner as in FIG. 1A. Specifically, in accordance with several embodiments of the present invention, the presentation of information on the display panel 110 is changed in response to a change in the orientation of the control device 100.

In some embodiments, the presentation of information is selectable by a user of the control device 100. In one embodiment for example, the user is able to communicate with the control device 100 via a communication link (e.g, Ethernet) utilizing the I/O port 106 of the device. In another embodiment, a separate switch is utilized so as to allow the user to change the presentation of information on the display panel 106.

In yet other embodiments, the control device 100 is configured to sense its orientation and automatically change the presentation of content on the display panel based upon the orientation of the control device 100 (and display panel 110).

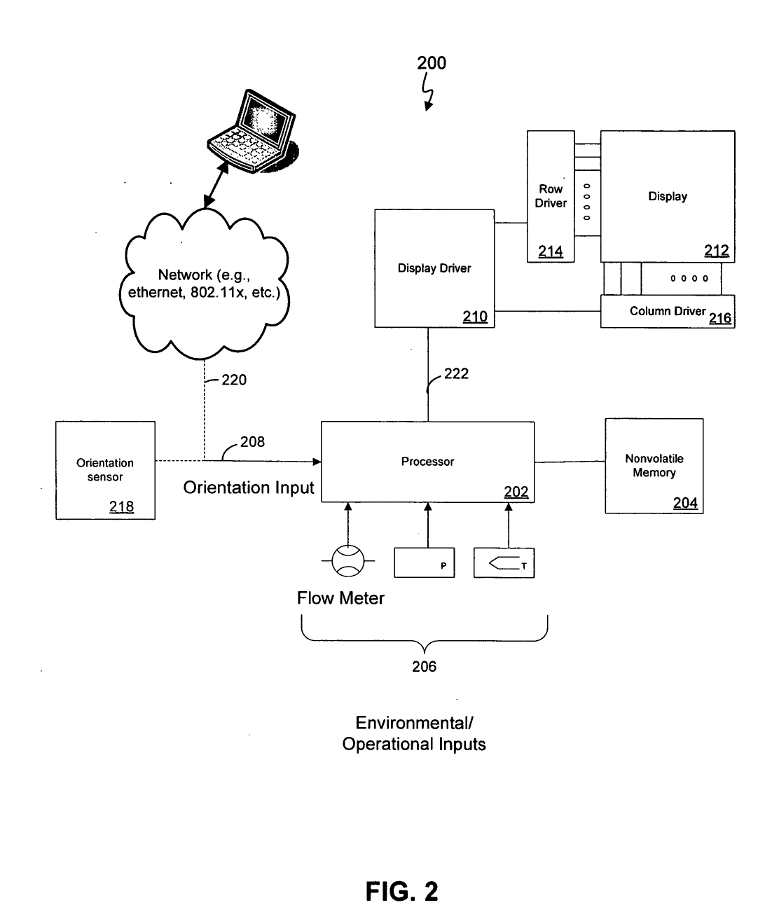

Referring next to FIG. 2, shown is a block diagram 200 depicting functional components of the control device 100 in accordance with one embodiment of the present invention. As shown, a processor 202 is coupled to nonvolatile memory 204, a collection of environmental sensors 206, an orientation input line 208 and a display driver 210. The display driver 210 is shown coupled to a display panel 212 via a row driver 214 and a column driver 216.

In the exemplary embodiment, the sensors-206 include a flow meter, a pressure-meter and a temperature meter, which provide status information to the processor 202. These inputs are exemplary only and one of ordinary skill in the art will recognize that other types of sensors are utilized in connection with other types of control devices.

The processor 202 in the present embodiment is configured to receive information (e.g., status information from the sensors 206) and generate display signals 222 (e.g., in serial form) that are processed by the display driver 210 so as to generate row and column signals that are converted to row and column drive voltages by the row driver 214 and column driver 216 respectively. Although the processor 202 is depicted in the exemplary embodiment as a single general purpose processor unit (e.g. a Motorola ColdFire 5282 processor), which includes the logic for inverting the displayed characters, in other embodiments the processor 202 is realized by a collection of discrete analog and/or digital components.

In some embodiments, the processor 202 alters the display signals 222 so that the altered display signals translate to a change in the presentation of the image on the display panel 212. For example, if the control device 100 is rotated 180 degrees as depicted in FIGS. 1A and 1B, any alphanumeric characters in the presented information are rearranged so that the information in the display panel 110, 212 reads from left to right. In addition, the display signals are altered so as to correct for the characters being upside-down.

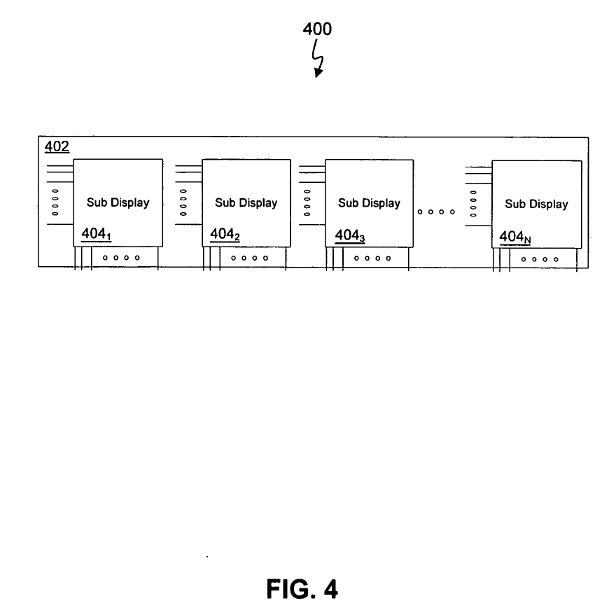

In the exemplary embodiment depicted in FIG. 2, the display panel 212 is a matrix addressable display that includes N rows and M columns. In another embodiment described with reference to FIG. 4, the display panel includes several sub-displays, which are each addressable by respective sets of rows and columns.

The orientation input 208 in the present embodiment allows an orientation signal to be sent to the processor 202 that is indicative of one or more orientations that the control device 100 is capable of being positioned in. In some embodiments, for example, the orientation signal is a command, which causes the processor 202 to provide display data 222 to the display driver 210 that flips the presentation of information on the display panel 212. In other embodiments, the orientation signal may include information indicating the orientation of the control device.

FIG. 2 depicts two alternative sources of the orientation signal: a communication link 220 to a user that allows the user to define the orientation of information on the display panel 212 and in the alternative, an orientation sensor 218 that is configured to sense the orientation of the control device 100. As shown in the embodiment depicted in FIG. 2, the communication link 220 is implemented as a network connection (e.g., Ethernet connection) to a man-machine interface (e.g., a mobile computer) that allows the user to define the orientation of the information on the display panel 212. In one embodiment, the orientation sensor 218 is a mechanical gravity switch, and in an alternative embodiment the orientation sensor 218 is an accelerometer.

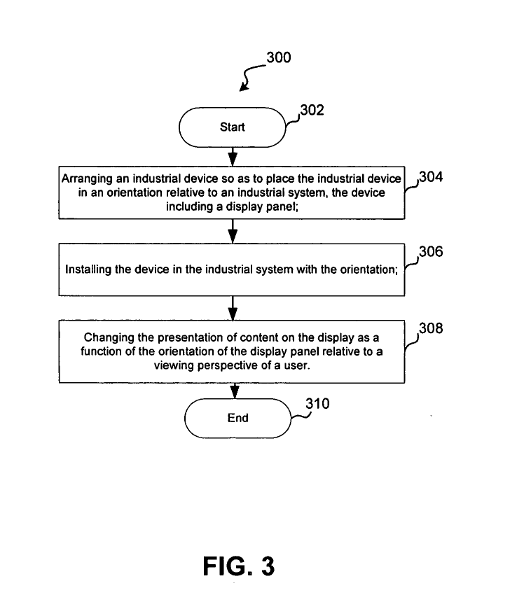

Referring next to FIG. 3, shown is a flowchart 300 depicting steps carried out when the presentation of information on the control device 100 is altered based upon an orientation of the control device 100. As depicted in FIG. 3, the control device 100 is initially arranged so as to place the control device 100 in an orientation relative to an industrial system (Blocks 302, 304). The device is then installed in the industrial system with the orientation (Block 308). Once installed, the presentation of content on the display panel 110, 212 of the control device is changed based upon the orientation of the display panel relative to a viewing perspective of the user (Blocks 308, 310).

As previously described, the user in one embodiment initiates the change in the presentation of information, and in an alternative embodiment a sensor (e.g., the orientation sensor 218) automatically sends the orientation signal 208 to the processor 202.

Referring next to FIG. 4, shown is a display panel 400 that is applicable for implementation as one embodiment of the display panels 110, 212 depicted in FIGS. 1 and 2. As shown, the display panel 400 in this embodiment includes N sub-displays 404₁₋₄, and each of the sub-displays 404₁₋₄ is a matrix addressable display (e.g., a 5×8 matrix addressable display). One of ordinary skill in the art will recognize that the configuration depicted in FIG. 2 is adaptable so as to be capable of driving the sub-displays of the display panel 402.

In conclusion, the present invention provides, among other things, a system, apparatus and method for displaying information on a control device. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for presenting information from an industrial device to a user;
arranging the industrial device so as to place a display panel of the industrial device in an orientation relative to an industrial system;
installing the industrial device in the industrial system so as to fix the orientation of the display panel with the orientation; and
changing the presentation of content on the display panel in response to the orientation of the display panel relative to a viewing perspective of a user.

2. The method of claim 1 including receiving an instruction from a user of the industrial device, wherein the changing the presentation is in response to the instruction from the user.

3. The method of claim 1, including:
sensing the orientation of the industrial device; and
generating a signal indicative of an orientation of the industrial device;
wherein the changing the presentation includes changing the presentation of the content as a function of the signal.

4. The method of claim 1, wherein the changing the presentation includes changing an order of characters on the display so as to render the characters in the same order from the perspective of the user regardless of the orientation of the display.

5. The method of claim 1, including:
driving a plurality of sub-displays, each of the sub-displays being configured to present a character, wherein the changing the presentation includes switching the sub-displays utilized for presenting the same information.

6. An industrial apparatus comprising:
at least one connector, wherein the at least one connector is configured so as allow the industrial apparatus to be coupled to the industrial system in a plurality of orientations relative to an industrial system;
a display panel configured to display status information relating to the industrial system to a user; and
a processor configured to receive an orientation signal, wherein the orientation signal is indicative of at least one of the plurality of orientations, wherein the processor is configured to alter the presentation of the status information on the display panel in response to the orientation signal.

7. The apparatus of claim 6 including an input module coupled to the processor, wherein the input module is configured to allow the user to send the orientation signal to the processor.

8. The apparatus of claim 6 including an orientation sensor, wherein the orientation sensor is configured to sense an orientation of the industrial apparatus and provide the orientation signal.

9. The apparatus of claim 6, wherein the display panel is a matrix addressable display panel.

10. The apparatus of claim 6, wherein the display panel includes at least two sub-displays, wherein each of the sub-displays is capable of displaying at least a portion of the status information.

11. The apparatus of claim 10, wherein at least one of the sub-displays is matrix-addressable.

12. The apparatus of claim 6 including a housing coupled to the display panel and the connector so as to render the display panel fixed relative to the position of the at least one connector.

13. The apparatus of claim 6, wherein the status information includes status information selected from the group consisting of temperature information, pressure information and flow information.

14. An industrial apparatus comprising:
means for coupling the industrial apparatus to an industrial system, wherein the means for coupling includes means for coupling the industrial apparatus to the industrial system in a plurality of orientations;
means for receiving an orientation signal, wherein the orientation signal is indicative of one of the plurality of orientations;
means for receiving status information relating to the industrial system;
a display panel configured to receive display signals and to display status information, the display signals including the status information relating to the industrial system; and
means for generating the display signals, wherein the means for generating the display signals includes means for changing the display signals in response to the orientation signal so as to change a presentation of the status information on the display panel.

15. The apparatus of claim 14 including means for generating an orientation signal based upon the orientation of the apparatus.

16. The apparatus of claim 14 including means for receiving an orientation signal from a user of the apparatus.

17. The apparatus of claim 14 including means for generating the status information, wherein the status information includes status information selected from the group consisting of temperature status, pressure status and flow status.

18. The apparatus of claim 14, wherein the display panel is a matrix addressable display panel, and wherein the means for generating display signals includes means for generating and applying row and column drive voltages to the display panel in response to the display signals.

19. The apparatus of claim 14, wherein the display panel includes a plurality of display sub-displays.

20. The apparatus of claim 14 including an actuator configured to control an aspect of the industrial system.
